(19) United States
(12) Patent Application Publication
(10) Pub. No.: US 2019/0210439 A1
(43) Pub. Date: Jul. 11, 2019

(54) INTEGRATED GLASSRUN AND BRIGHT STRIP ASSEMBLY FOR IN-LAID VEHICLE DOOR CONSTRUCTION

(71) Applicant: COOPER-STANDARD AUTOMOTIVE INC., Novi, MI (US)

(72) Inventors: Michael Williamson, Rochester, MI (US); Thomas Maliskey, Marine City, MI (US); Rod Bara, Rochester Hills, MI (US)

(21) Appl. No.: 16/326,098

(22) PCT Filed: Aug. 17, 2017
(86) PCT No.: PCT/US17/47414

§ 371 Date: Feb. 15, 2019

Related U.S. Application Data
(60) Provisional application No. 62/376,098, filed on Aug. 17, 2016.

(51) Int. Cl. B60J 10/76; B60J 10/265; B60J 10/18

(52) U.S. Cl. CPC B60J 10/76; B60J 10/32; B60J 10/18; B60J 10/265

(57) ABSTRACT

An integrated glassrun and bright strip assembly includes a body forming a glassrun portion of the assembly, and a bright strip mounting region extends outwardly therefrom to receive an associated bright strip. The bright strip is either a separate component or an integral portion of a support member. If a separate component, the bright strip is mechanically mounted to the integrated assembly. If the bright strip is an integral portion of the support member, a portion of the support member is exposed on a show surface of the integrated assembly.

### BACKGROUND

This disclosure claims the priority benefit of U.S. provisional application Ser. No. 62/376,098, filed Aug. 17, 2016, the disclosure of which is expressly incorporated herein by reference.

This disclosure relates to a weatherstrip also known as a glassrun assembly, and particularly a header region of a glassrun assembly of a vehicle. It will be appreciated that aspects of the present disclosure may find application in related environments and applications.

It is known in the art to provide a glassrun assembly along a header portion of a door window opening that receives an upper perimeter edge of the door window in a closed position. Further, it is known to secure a bright strip to the vehicle in the same region. However, where the vehicle uses a more robust in-laid door construction, the glassrun assembly is typically manufactured, supplied, and assembled as a separate component from the bright strip assembly. OEMs source these products as separate components in an in-laid door construction.

A need exists for an improved arrangement that provides both of the glassrun and bright strip functions in a single integrated arrangement, as well as still other features and benefits.

### SUMMARY

An integrated glassrun and bright strip assembly is provided for an in-laid door structure of a vehicle.

An integrated glassrun and bright strip assembly includes a body forming a glassrun portion of the assembly, and a bright strip mounting region extends outwardly therefrom to receive an associated bright strip. The bright strip is either a separate component or an integral portion of a support member. If a separate component, the bright strip is mechanically mounted to the integrated assembly. If the bright strip is an integral portion of the support member, a portion of the support member is exposed on a show surface of the integrated assembly.

The glassrun portion and the bright strip mounting region share a common leg for securing the integrated assembly to the vehicle.

The weatherstrip body is formed of one of an EPDM, thermoplastic elastomer (TPE), or thermoset elastomer, and a rigid support member is received within the body.

The body is coextruded over the rigid support member.

The bright strip either is a separate component mechanically mounted to the bright strip mounting region, or is formed by an exposed portion of the support member.

A primary advantage is the ability to integrate separate structures/components into a single integrated weatherstrip assembly.

Another benefit is improved interfit of previously provided separate components.

A related advantage is the elimination of tolerance stack-up issues.

Still another benefit is associated with ease of assembly.

Benefits and advantages of the present disclosure will become more apparent from reading and understanding the following detailed description.

### BRIEF DESCRIPTION OF THE DRAWINGS

FIG. 1 is a schematic representation of a portion of a vehicle.

FIG. 2 is a cross-sectional view generally along the lines A-A of FIG. 1 of a preferred embodiment of the present disclosure.

FIG. 3 is a cross-sectional view also generally along the lines A-A of FIG. 1 of an alternate, preferred embodiment of the present disclosure.

### DETAILED DESCRIPTION

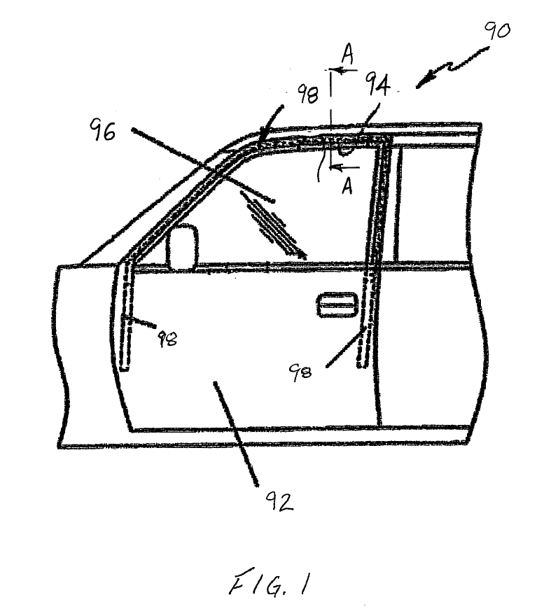

FIG. 1 shows a portion of a vehicle 90, and particularly an automotive vehicle such as a car or truck that includes a door 92 having an opening 94 that receives a movable window 96. The window 96 is selectively lowered and raised relative to the door 92 to open and close the door opening 94. Perimeter edges of the window 96 are sealed where the window edge mates with the door 92, particularly through use of a weatherstrip or weatherseal assembly 98. The weatherstrip assembly 98 typically includes one or more weatherstrip portions that seal various regions of the window 96 such as along a belt line portion of the window opening, along front and rear pillar portions, and across a header portion. The structure and function of the components of vehicle door 92, opening 94, window 96 and weatherstrip assembly 98 as generally described in this paragraph are well known in the industry.

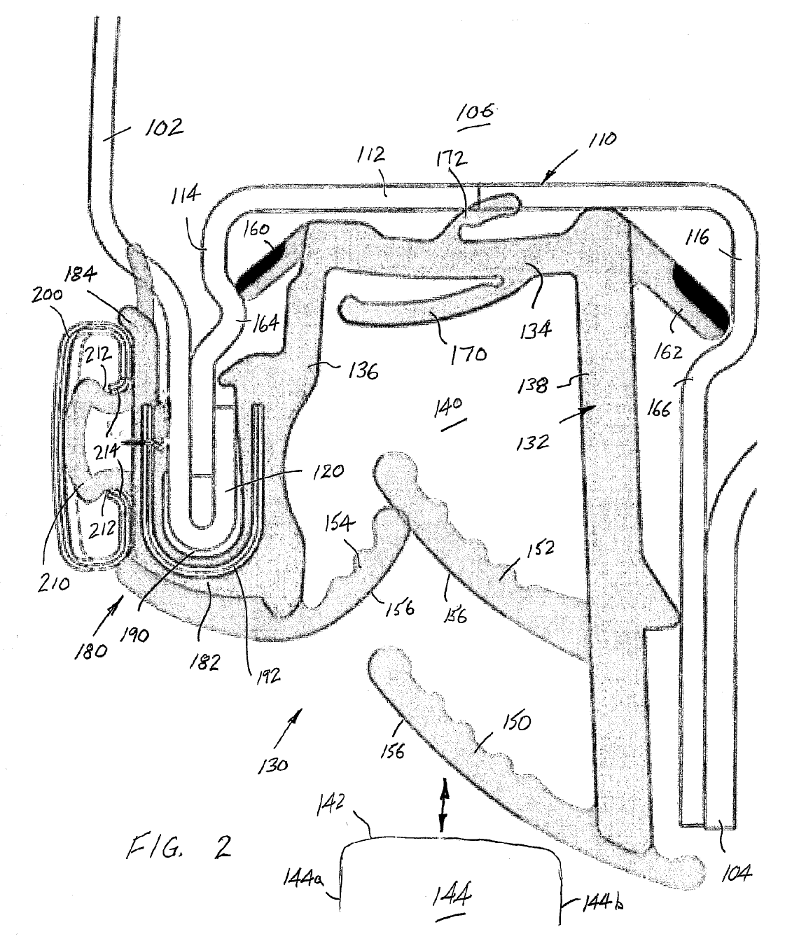

With continued reference to FIG. 1 and additional reference to FIG. 2, vehicle door 92 includes a first or outer door panel 102 and a second or inner door panel 104. Bridging a gap 106 between the inner and outer door panels 102, 104 is a generally U-shaped support carrier 110 that includes a base 112 and first/outer leg 114 and second/inner leg 116. The outer leg 114 of the support carrier 110 has a terminal portion received in a folded or turned-back hem 120 of the outer door panel 102. The inner leg 116 of the support carrier 110 abuts against and is secured (e.g. welded) to the inner door panel 104. This is a general description of a well-known in-laid door structure which is the most robust of three general types of door structures used in the vehicle industry. A second type of door structure (not shown) is referred to as a frame under glass construction, while the third type of door structure (also not shown) is generally referred to as a headerless construction such as used in cabriolet or convertible vehicles. Since these second and third types of door structures are well known to those skilled in the art (automotive industry), they are not shown or described herein for purposes of brevity.

Shown in FIG. 2 of the present disclosure is a modified glassrun and bright strip assembly 130 for use in the in-laid door structure. The modified glassrun and bright strip assembly 130 has a body 132 that includes a first portion or base 134 and first and second legs 136, 138 extending from opposite ends of the base. Together, the base 134 and legs 136, 138 form a generally U-shaped (illustrated as an inverted U-shape in the orientation of FIG. 2) glassrun portion of the integrated body 132 that enclose a cavity 140 dimensioned to receive a perimeter portion (such as upper edge 142) of a movable window 144 in an opening of the vehicle door. In addition, seal lips 150, 152, 154 extend from the first and second legs 136, 138. The seal lips 150, 152, 154 preferably include a low friction surface coating 156 that allows the individual seal lips to slidingly engage opposite faces 144a and 144b of the window 144.

In addition, the glassrun portion of the assembly 130 includes retaining flanges 160, 162. The retaining flanges 160, 162 cooperate with reduced dimensioned portions or shoulders 164, 166, respectively, formed in the legs 114, 116 of the support carrier 110. Still further, the glassrun portion of the modified glassrun and bright strip assembly 130 includes extending cushion arms 170, 172 shown extending from opposite faces of the base 134 of the generally U-shaped glassrun portion. The arms 170, 172 extend outwardly from the base 134 so that the first arm 170 is configured for selective contact by perimeter edge 142 of the window, which can depress the first arm toward the base, and likewise the second arm 172 can be compressed between the base 134 and the base 112 of the support carrier 110. At least the first arm 170 may also include a harder, more durable wear material that is suitable for repeated contact with the edge 142 of the window 144.

The body 132 of the modified glassrun and bright strip assembly 130 includes a generally U-shaped attachment portion 180 (shown as an upright U-shape in the orientation of FIG. 2) that has a second base 182 extending from the first leg 136 (i.e., the first leg is common to both the glassrun and attachment/bright strip features of the assembly). The second base 182 is generally parallel to and offset from the first base 134 of the assembly body 132, and a third leg 184 extends from the second base in a direction generally parallel with that of the first leg 136. In this manner, the second base 182, first leg 136, and third leg 184 together enclose a cavity 190 that receives and is attached to the hem 120 of the outer door panel 102, as well as the terminal end of the first leg 114 of the support carrier 110. An internal support or carrier 192 also has a generally U-shape in cross-section for receipt in the first leg 136, second base 182, and third leg 184, respectively, of the attachment portion 180. The carrier 192 is preferably metal or plastic and deformable into gripping engagement to attach the body 132 of the modified glassrun and bright strip assembly 130 to the vehicle door. In the preferred arrangement as shown in FIG. 2, the generally U-shapes of the glassrun body 132 and the attachment portion 180 open in opposite directions (i.e., the U-shapes are oriented or open in opposite directions that are approximately 180° apart relative to one another).

In the past, a bright strip 200 (which alternatively could be a reveal or other show surface structure facing outwardly from the vehicle door, and thus will be referred to herein as a “bright strip”) was a separate component in an in-laid door structure. Here, however, the bright strip 200 is integrally joined with the mounting structure of the bright strip assembly that receives the bright strip (e.g., the mounting structure is commonly formed in a co-extrusion process) with the glassrun portion to form the integrated glassrun and bright strip assembly 130. A protrusion or mushroom-shaped mounting structure 210, for example, faces outwardly from the third leg 184. Again, preferably the mounting structure 210 is co-extruded with the remainder of the assembly 130. The mounting structure 210 includes undercut portions 212 that receive inwardly curled, terminal edges 214 of the bright strip 200 for securely fastening the bright strip to the assembly 130. Common materials for forming the bright strip include stainless steel or aluminum, although other reveal surfaces can be a different colored material (e.g. plastic such as a TPE, thermoset elastomer, etc.) than the underlying material of the body (e.g., EPDM, TPE, thermoset elastomer, or the like).

As a result, whereas in the past a first sourced component was the glassrun and a second sourced component was the bright strip with distinct (structurally separate) mounting or attachment components for securing the respective components to the vehicle, the modified glassrun and bright strip assembly 130 of the present disclosure is sourced as a single component that serves the combined purposes of the glassrun functionality and the show feature (bright strip or reveal). As a result, interfit and tolerance stackup issues are avoided, and assembly of the integrated glassrun/bright strip assembly is simplified. Moreover, the bright strip 200 can be preassembled to the modified glassrun and bright strip assembly 130 prior to shipment to the OEM, or the bright strip can be separately assembled by assembly line personnel once the combined glassrun and bright strip assembly is mounted to the in-laid door structure.

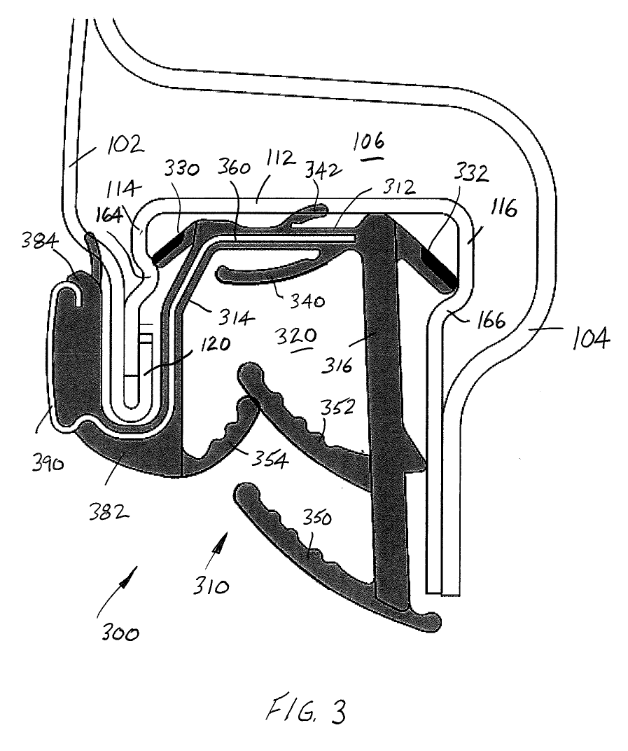

FIG. 3 is a cross-sectional view similarly taken along the lines A-A in FIG. 1. FIG. 3 shows an alternate embodiment to the embodiment described above in connection with FIG. 2. One skilled in the art will appreciate a number of similarities between the embodiments of FIGS. 2 and 3. Since the structure of the inner and outer door panels and the generally U-shaped support carrier are the same, like reference numerals have been used to refer to like components, while new reference numerals refer to the integrated glass run and bright strip assembly 300. More specifically, the integrated assembly 300 includes a glassrun portion 310 that includes a first portion or base 312 and first and second legs 314, 316 extending from opposite ends of the base. Together, the base 312 and legs 314, 316 form the generally U-shaped glassrun portion 310 of the integrated assembly 300 and enclose a cavity 320 that receives a perimeter, upper edge of a movable window (not shown) in a manner similar to that shown in FIG. 2. Retaining flanges 330, 332 engage reduced dimension portions or shoulders 164, 166, respectively, of the generally U-shaped support carrier 110 to retain the glassrun portion in the support carrier. Cushion arms 340, 342 extend from opposite faces of the base, and seal lips 350, 352, 354 extend from the legs 314, 316 for engaging opposite faces of the window, again, in a manner akin to the embodiment of FIG. 2.

A rigid core or support member 360 extends at least partially through the glassrun portion 310. In this particular instance, the support member 360 extends through the base 312 and through the second leg 314 of the glassrun portion 310. Here, the second leg 314 of the glassrun portion 310 also forms a common leg of a generally U-shaped attachment portion 380. The attachment or bright strip portion 380 includes a base 382 and a further, outer leg 384 that faces outwardly from the vehicle. Preferably, the support member 360 extends through the base 382 and is at least partially exposed at 390 along the outer leg 384. Thus, the exposed portion 390 of the support member 382 (e.g., aluminum) can serve as a bright strip or different color surface distinct from the coextruded material that forms the remainder of the weatherstrip. For example, it is common for the weatherstrip to be an EPDM rubber or TPE (thermoplastic) thermoset elastomer, or equivalent material as commonly used in connection with the desired glassrun and bright strip structures commonly used in the weatherstrip components associated with vehicles. Consequently, the cross-sectional configuration of the support member 360 and the remaining material of the integrated weatherstrip assembly 300 that forms the glassrun portion 310 and the bright strip portion 380. It is also noted that the exposed portion 390 has smoothly rounded edges, i.e., a C-shaped cross-section, where the surrounding EPDM or elastomer material encompasses the support member in this region. This embodiment illustrates that alternative configurations can be used in connection with the integrated weatherstrip assembly for use in an in-laid door structure without departing from the scope and intent of the present disclosure.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept, or if they include equivalent structural elements with insubstantial differences.

What is claimed is:

1. An integrated glassrun and bright strip assembly comprising:
a body having a first base and first and second legs forming a generally U-shaped glassrun portion and defining a cavity therebetween dimensioned to receive a perimeter edge of an associated door window, each of the first and second legs having at least one seal lip extending from the body into the cavity for selective sealing engagement with opposite faces of the associated door window, a generally U-shaped attachment portion that includes a second base extending from the first leg in a parallel direction opposite and offset from the first base and also including a third leg that together with the first leg and the second base form the generally U-shaped attachment portion that define a cavity therebetween dimensioned to receive a terminal portion of an associated door panel therein for mounting the integrated assembly thereto; and
a bright strip mounting region extending outwardly from the third leg, the mounting region configured to receive an associated bright strip.

2. The integrated assembly of claim 1 wherein the U-shaped attachment portion includes a reinforcement member therein to aid in gripping engagement with the associated door panel.

3. The integrated assembly of claim 1 wherein the U-shaped attachment portion and the U-shaped glassrun portion open in directions 180 degrees apart.

4. The integrated assembly of claim 1 wherein the bright strip mounting region includes a mushroom-shaped cap extending from the third leg and interconnected thereto by a reduced dimension portion forming opposed undercut regions that receive opposite legs of the associated bright strip.

5. The integrated assembly of claim 4 wherein the reduced dimension portion extends outwardly from the third leg in a direction perpendicular thereto.

6. The integrated assembly of claim 1 wherein the glassrun portion and the attachment portion each have an extrudable cross-sectional profile so that the integrated assembly can be co-extruded.

7. The integrated assembly of claim 1 wherein the glassrun portion includes outwardly projecting regions extending from the first and second legs for interference engagement with detent portions of a U-shaped support carrier to retain the integrated assembly therein.

8. The integrated assembly of claim 1 further comprising a bright strip wherein the bright strip is defined by a portion of a support member.

9. The integrated assembly of claim 1 wherein the bright strip is a separate component that is mechanically joined to the bright strip mounting region.

10. A method of forming an integrated glassrun and bright strip assembly, the method comprising:
forming a body having a first base and first and second legs forming a generally U-shaped glassrun portion and defining a cavity therebetween dimensioned to receive a perimeter edge of an associated door window;
providing each of the first and second legs with at least one seal lip extending from the body into the cavity for selective sealing engagement with opposite faces of the associated door window;
forming a generally U-shaped attachment portion with the body where the attachment portion includes a second base extending from the first leg in a parallel direction opposite and offset from the first base and also including a third leg that together with the first leg and the second base form the generally U-shaped attachment portion that define a cavity therebetween dimensioned to receive a terminal portion of an associated door panel therein for mounting the integrated assembly thereto; and
forming a bright strip mounting region extending outwardly from the third leg, the mounting region configured to receive an associated bright strip in snap-fit relation.

11. The method of claim 10 further including incorporating a reinforcement member in the U-shaped attachment portion to aid in gripping engagement with the associated door panel.

12. The method of claim 10 further including forming the U-shaped attachment portion and the U-shaped glassrun portion to open in directions 180 degrees apart.

13. The method of claim 10 further including forming a mushroom-shaped cap extending from the third leg and interconnecting the cap thereto by a reduced dimension portion forming opposed undercut regions that receive opposite legs of the associated bright strip.

14. The method of claim 13 further including orienting the reduced dimension portion to extend outwardly from the third leg in a direction perpendicular thereto.

15. The method of claim 10 further comprising co-extruding the glassrun portion and the attachment portion to form the integrated assembly.

16. The method of claim 10 further comprising providing outwardly projecting regions extending from the first and second legs of the glassrun portion for interference engagement with detent portions of a U-shaped support carrier to retain the integrated assembly therein.

17. The method of claim 10 further comprising providing a bright strip dimensioned for mechanical engagement with the bright strip mounting region.

18. The method of claim 17 further comprising snap-fitting the bright strip to the bright strip mounting region.

19. The method of claim 10 further comprising forming a bright strip from a portion of a support member mounted in the body.

20. The method of claim 10 further comprising co-extruding the body and bright strip mounting region.

21. The method of claim 20 further comprising including a support member in at least portions of the coextruded body and bright strip mounting region.
